(19) United States
(12) Patent Application Publication
(10) Pub. No.: US 2019/0039444 A1
(43) Pub. Date: Feb. 7, 2019

(54) FLEXIBLE GLASS RUN PROFILE WITH MULTIPLE MATERIALS FOR DIFFERENT FUNCTIONAL BENEFITS

(71) Applicant: COOPER-STANDARD AUTOMOTIVE, INC., Novi, MI (US)

(72) Inventor: Marc Brookman, Livonia, MI (US)

(73) Assignee: COOPER-STANDARD AUTOMOTIVE, INC.

(21) Appl. No.: 16/056,972

(22) Filed: Aug. 7, 2018

Related U.S. Application Data
(60) Provisional application No. 62/542,072, filed on Aug. 7, 2017.

(51) Int. Cl. B60J 10/16; B60J 10/76; B60J 10/277; B29C 47/00; B29C 47/06

(52) U.S. Cl. CPC B60J 10/16; B60J 10/76; B60J 10/277; B29K 2021/003; B29C 47/062; B29K 2995/007; B29C 47/003

(57) ABSTRACT

A weatherstrip assembly such as a glass run, and the associated method of forming the glass run, includes a body having a generally U-shaped conformation that includes a base portion, and first and second legs extending from the base portion to define a cavity. First and second seal lips extend from the first and second legs, respectively. First and second hinges are interposed between the first leg and first seal lip, and the second leg and second seal lip, respectively. The hinges are formed of a first material different than a second material of the seal lips where the first material has high elasticity, and low compression set properties.

The application claims the priority benefit of U.S. provisional application Ser. No. 62/542,072, filed Aug. 7, 2017, the entire disclosure of which is expressly incorporated herein by reference.

### BACKGROUND

This application is directed to a weatherstrip or weatherseal, and more particularly to a glass run such as used in an automotive vehicle.

A common cross-sectional construction or profile of a glass run is a U-shaped body having a base portion with first and second walls or legs extending from ends of the base portion to collectively define a cavity that receives an edge of a window. Typically, first and second seal lips extend from outer ends of the first and second legs, respectively, where the seal lips extend into the cavity for sealing engagement with opposite faces of the window.

Early glass run profiles were a single durometer material. As profiles increased in complexity, different materials were incorporated into the body where the goal was to improve installation. That is, prior arrangements typically used a soft material in the hinge area, conducive to folding for purposes of installation, and capable of opening and flexing to accommodate desired positioning of the seal lips relative to the window surfaces when installed in the automotive vehicle.

It has been generally taught to use different materials in the glass run profile, for example coextruding different portions of the glass run profile from different materials; however, the prior emphasis has primarily centered on forming the seal lips of a first material and forming the U-shaped body of a different, second material. Alternatively, or additionally, those surfaces of the seal lips that contact the window are sometimes coated (e.g., co-extrusion) with a material that has low friction or good sliding qualities.

Another issue relating to use of multiple materials such as a co-extruded assembly is that the interface between the different materials can adversely impact the aesthetics of the final assembly. Specifically, knit lines formed between adjacent, different materials are undesirable.

Analysis of the functional aspects of the glass run profile illustrate that a key to a high-quality seal relates to the hinge area formed at the interface of the legs with the seal lips. Generally, it is believed that the effectiveness of the seal lips primarily relates to the operation of the hinge, and the profile and material of the seal lips is secondary. Consequently, a need exists for a glass run assembly that focuses on these attributes in a manner that is flexible, durable, and highly functional in design and that addresses manufacturability, complexity, effectiveness and functionality in a cost-efficient manner.

### SUMMARY

A flexible glass run is provided that uses multiple materials to address different functional benefits.

A preferred glass run includes a body having a generally U-shaped conformation that includes a base portion, and first and second legs extending from the base portion to define a cavity. First and second seal lips extend from the first and second legs, respectively. First and second hinges are interposed between the first leg and first seal lip, and the second leg and second seal lip, respectively. The hinges are formed of a first material different than a second material of the seal lips where the first material has high elasticity, and low compression set properties.

The body is formed of a different, third material than the first material of the hinges.

A coating is received over at least portions of the first and second seal lips that face the associated window edge.

The coating preferably extends over first and second junctions formed between the first and second seal lips and the first and second hinges in order to cover a transition between the first and second materials.

The first material extends over distal ends of the first and second legs in order to cover a transition between the first and third materials i.e., between the hinges and the body (legs).

A preferred arrangement has a high elasticity, low compression set, first material, the second material is a low durometer material, and the third material is a high durometer, dense or microdense material.

In one preferred arrangement, the first material has a Shore hardness of about 55 A to about 75 A, the second material has a Shore hardness of about 55 A to about 75 A, and the third material has a Shore hardness of about 70 A to about 45 D.

A method of forming a glass run assembly includes forming a generally U-shaped body that includes a base portion and first and second legs extending from the base portion to define a cavity. The method further includes providing first and second seal lips that extend from the first and second legs, respectively, and incorporating a first hinge between the first leg and first seal lip, and a second hinge between the second leg and second seal lip, respectively, where the first and second hinges are formed of a first material different than a second material of the seal lips, and the first material has high elasticity and low compression set properties.

The method can preferably include covering an interface of the first and second hinges with the first and second seal lips, respectively.

Further, the method may include forming the first and second hinges on outer ends of the first and second legs of the body to cover an interface therebetween.

A primary benefit is the ability to use desired materials at preselected locations in the profile of the glass run in order to provide different functional benefits.

Another advantage resides in the ability to minimize cost of manufacture while providing desired performance characteristics.

Still another feature is that the performance of seal lips are associated with the high performance material used for the hinges, and thereby allow the seal lips to be formed of a less expensive material without any loss in functionality, and similarly the body of the glass run can be formed a less expensive material, i.e., due to the importance of the hinge portions with respect to sealing performance, the hinge portions are formed of a more expensive material and the overall cost of the glass run assembly is cost effective due to limiting the higher cost material to the hinge portions only.

Other benefits and advantages of the present disclosure will become more apparent from reading and understanding the following detailed description.

### BRIEF DESCRIPTION OF THE DRAWINGS

FIG. 1 shows a door of an automotive vehicle.

FIG. 2 is a cross-sectional illustration of a finite element analysis undertaken on a glass run.

FIG. 3 is a cross-sectional view of a portion of the glass run of the present disclosure.

### DETAILED DESCRIPTION

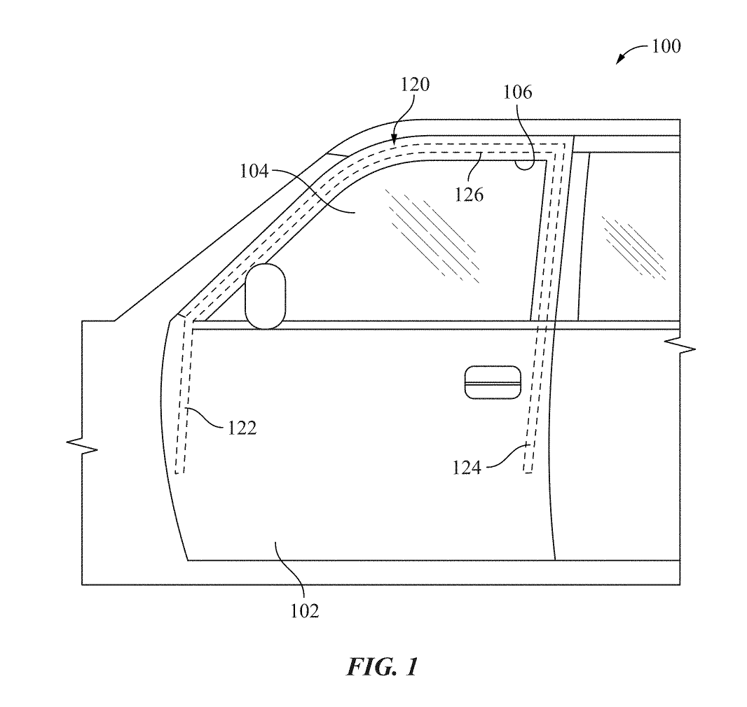

Turning to FIG. 1, a portion of an automotive vehicle 100 is illustrated, and more particularly an automotive door 102 that includes a movable window 104 that is selectively raised and lowered relative to an opening 106 in the door. A weatherstrip assembly such as a glass run assembly (or sometimes referred to as a glass run) 120 is mounted to the door 102. The weatherstrip assembly described and shown herein is representative of and likewise could also refer to and be used in connection with other vehicle weatherstrips or seals such as a belt seal, cutline seal, etc., used on an automotive vehicle that seals between adjacent vehicle surfaces. One skilled in the art will recognize how the features of the present disclosure could be used in alternative weatherstrips. The glass run 120 includes first and second pillar portions 122, 124 that extend in a generally vertical direction from header portion 126. The first and second pillar portions 122, 124 receive vertical edges of the window 104 as the window is raised and lowered relative to the window opening 106 in the door, while the header portion 126 of the glass run 120 receives an upper edge of the window when the window is in the raised position.

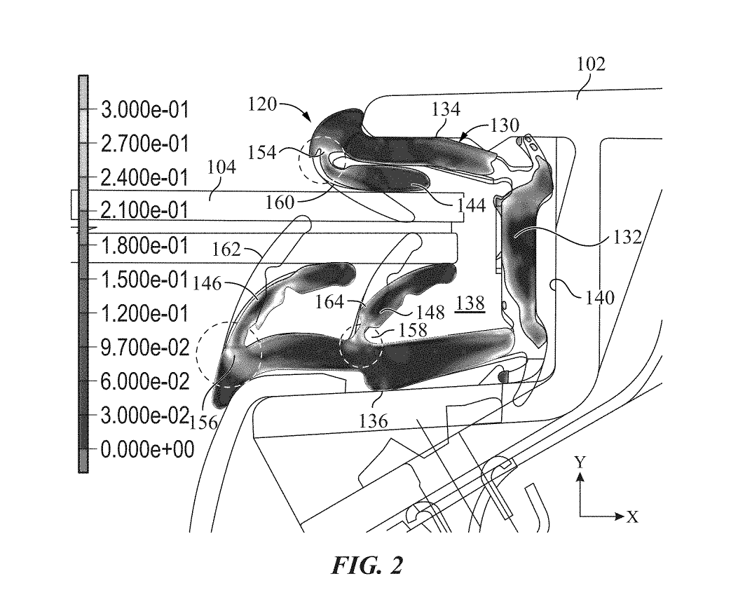

FIG. 2 is a cross-sectional representation of the strains imposed on the glass run 120. Specifically, a conventional glass run 120 has a generally U-shaped body 130 that includes a base portion 132 and first and second sidewalls or legs 134, 136 that extend outwardly from opposite edges of the base portion. The U-shaped body 130 forms an internal cavity 138 that receives an edge of the window 104. In a manner well known in the art, the door 102 includes a structure forming a cavity 140 that receives the glass run 120. Legs 134, 136 of the glass run 120 preferably include at least one seal lip, namely first seal lip 144, and second seal lip 146 extending from the first leg 134 and the second leg 136, respectively, at a location spaced from the base portion 132. The seal lips 144, 146, and an additional or third seal lip 148 provided on the second leg 136, for example, are connected to the first and second legs 134, 136 via respective hinges 154, 156, 158. The seal lips 144, 146, 148 extend inwardly into the cavity 138 of the glass run 120 so that surfaces of the seal lips are contoured and the hinges urge the surfaces of the seal lips that face the window 104 to slidingly and sealingly engage opposite faces of the window. In some instances, a coating (e.g., a low friction coating) 160, 162, 164 is provided on the window engaging surfaces of the respective seal lips 144, 146, 148 that face and selectively engage the opposite surfaces of the window 104.

As illustrated in FIG. 2, different strains are imposed on the material of the glass run 120 that forms the body 130 (base portion 132, first and second legs 134, 136, and first, second, and third hinges 154, 156, 158) and the first, second, and third seal lips 144, 146, 148 during engagement with the window 104. This analysis (e.g., finite element analysis or FEA) evidences that the hinges 154, 156, 158 carry the bulk of the strain, i.e., are the areas of high strain, and that the energy or force is transferred through the seal lips 144, 146, 148 at the hinges 154, 156, 158.

In the past, a glass run was typically formed of a single durometer material. Subsequent developments began to use different materials at different locations (i.e., throughout the cross-sectional profile) of the glass run. For example, the industry generally preferred to use a harder material for the U-shaped body of the glass run while the seal lips were formed of a softer material. This manufacture typically made the hinges of the softer material used to form the seal lips and softer than the hard material of the U-shaped body that included the base and legs, because a common method of manufacture and assembly was to extrude or coextrude the glass run profile. As a part of that manufacturing process, the softer material used at the hinge allowed the legs of the glass run to be deployed from a splayed or open orientation and easily fold for mounting the glass run in the channel of the door, and thereby secure the glass run to the door. Thus, it was common to either manufacture the entire cross-sectional profile (base portion, legs, hinges, seal lips, etc.) of a single material, or alternatively manufacture the entire seal lip and hinge from the same, softer material and manufacture the body of the hard material.

The present disclosure, however, uniquely forms only the hinge areas 154, 156, 158 of a high elasticity, low compression set, functional material. The term “functional” is intended to generally mean portions or areas of the assembly where the strains are high and important or necessary to the seal function of the glass run 120. This functional material is a higher cost and thus it would not be contemplated to use the higher cost material for the entire cross-section or for major portions thereof since the overall cost of the glass run 120 would undesirably increase. As shown and described in this disclosure, using the higher cost, higher elasticity, lower compression set material only in those areas (i.e., seal lip hinge areas 154, 156, 158) where the desired engineered value is needed, obtains an improved glass run 120 that advantageously and judiciously (i.e., carefully and sparingly) uses this more expensive material in select areas only of the glass run profile where the value is needed, and that results in a glass run that is practical, efficient, and cost effective.

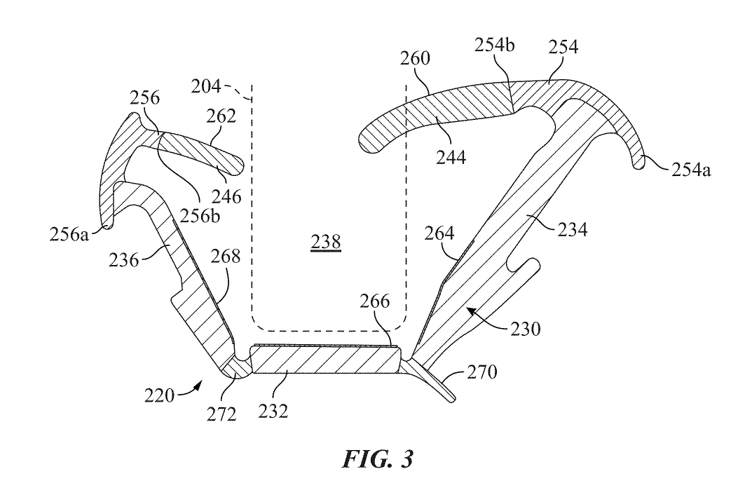

More specifically, and with reference to FIG. 3, like reference numerals in the “200” series will be used to describe like components for purposes of brevity and understanding (e.g., in FIG. 1, the glass run was referenced as 120 and in FIG. 3 the glass run will be referred to as 220). The generally U-shaped body 230 includes base portion 232 and first and second legs 234, 236. Each of the base portion 232 and the legs 234, 236 is preferably formed of a low-cost, high durometer, non-functional dense or microdense material, for example having a hardness of about 75 Shore A hardness to about 45 Shore D hardness (also referred to herein as the third material). An exemplary material that meets these parameters in association with the embodiments of FIG. 2 or 3 includes thermoplastic and thermoset elastomers such as EPDM and TPE, or another equivalent material that meets these desired parameters.

Each leg 234, 236 is interconnected to the base portion 232 with a low-cost, low durometer, non-functional material, for example possibly a dense or microdense material having a hardness of about 55 to about 75 Shore A hardness (also referred to herein as the second material). An exemplary material that meets these parameters is TPE or EPDM rubber or an equivalent material that meets these desired parameters.

In addition, the seal lips 244, 246 are also preferably formed of the low-cost, low durometer, non-functional material, for example possibly a dense or microdense material having a hardness of about 55 to about 75 Shore A hardness. Although it need not be the same material as is used to interconnect the base portion and legs, the seal lips could be formed of the same material, and is most notable because it need not be a highly functional material.

The hinges 254, 256 interposed between the respective first and second legs 234, 236 and the first and second seal lips 244, 246 are preferably a high elasticity, low compression set, functional material having a hardness of about 55 to about 75 Shore A hardness (also referred to herein as the first material). An exemplary material that meets these parameters is an EPDM rubber, a TPE, or equivalent material that meets these desired specifications. The material used to form the hinges 254, 256 is substantially more expensive than those materials that form the remainder of the cross-sectional profile of the glass run 220. It is evident that the high elasticity, low compression set material is used in that area of the hinges 254, 256 subject to increased flexure and increased forces of the glass run 220 (those hinge areas as illustrated and encircled in FIG. 2).

Being formed of a highly functional material, it will be appreciated, therefore, that due to the increased cost, the amount of this material used in the profile will be minimized. Thus, even though there is a general desire to minimize the amount of this material used in the cross-section profile of the glass run due to cost, this material that forms the hinges 254, 256 also advantageously extends over an entirety of a distal end of each of the first and second legs 234, 236. The distal end of each leg 234, 236 is that portion of the legs spaced furthest from the base portion 232. In this manner, and in part for aesthetic reasons, the material that forms the hinges 254, 256 entirely covers the distal end of the first and second legs 234, 236 so that the transitions (knit lines) between the different materials forming the legs and the hinges 254, 256 are not evident, i.e., the interfaces between the legs and the hinges is completely covered by the hinge material. It is for this reason that the material extends into the region denoted by reference numerals 254a, 256a even though the functionality of the material is not required in these regions.

Similarly, the interface/knit lines 254b, 256b between the hinges 254, 256 and the seal lips 244, 246, respectively, would otherwise be evident and detract from the aesthetics. However, the low friction coating 260, 262 on the first and second seal lips 244, 246, respectively covers the interface/knit line 254b, 256b between the low-cost material of the seal lips and the high cost material of the hinges 254, 256. Thus, the low friction coating 260, 262 extends over those surfaces of the seal lips 244, 246 that are designed for sliding, sealing engagement with opposite surfaces of the window 204 in a manner similar to that of the conventional glass run of FIG. 1. Further, low friction coating 264, 266, 268 is preferably provided along select regions of the first and second legs 234, 236 and the base portion 232 that are designed for engagement with the window 204. A preferred material for the coextruded low friction coating or slip coat 260, 262, 264, 266, 268 is silicone impregnated TPE or an equivalent material that satisfies the material parameters.

It will also be appreciated that interconnecting regions 270, 272 that connect the base portion 232 with the respective legs 234, 236 may be formed of the same material that is used to form the legs, or could be a softer material such as used to form the seal lips 244, 246.

This written description uses examples to describe the disclosure, including the best mode, and also to enable any person skilled in the art to make and use the disclosure. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. For example, other vehicle weatherstrip or seal applications may employ the features and make use of the advantages achieved with the present disclosure (e.g., in a belt seal, or cutline seal) or a greater or lesser number of seal lips could be used in various applications without departing from the scope and intent of the present disclosure. Moreover, this disclosure is intended to seek protection for a combination of components and/or steps and a combination of claims as originally presented for examination, as well as seek potential protection for other combinations of components and/or steps and combinations of claims during prosecution.

It is claimed:

1. A weatherstrip assembly, the assembly comprising:
a body;
at least a first seal lip extending from the body; and
a first hinge interposed between the body and the first seal lip, the hinge formed of a first material different than a second material of the first seal lip where the first material has high elasticity, low compression set properties.

2. The weatherstrip assembly of claim 1 wherein the body is formed of a different, third material than the first material of the hinge.

3. The weatherstrip assembly of claim 1 further comprising a coating received over at least a portion of the first seal lip.

4. The weatherstrip assembly of claim 3 wherein the body is formed of a third material different than the first material.

5. The weatherstrip assembly of claim 4 wherein the first material extends over a portion of the body in order to cover a transition between the first and third materials.

6. The weatherstrip assembly of claim 1 wherein the body is formed of a third material different than the first material.

7. The weatherstrip assembly of claim 6 wherein the first material extends over a portion of the body in order to cover a transition between the first and third materials.

8. The weatherstrip assembly of claim 1 wherein the first material is a high elasticity, low compression set material having a Shore hardness of about 55 A to about 75 A.

9. The weatherstrip assembly of claim 8 wherein the second material is a low durometer material having a Shore hardness of about 55 A to about 75 A.

10. The weatherstrip assembly of claim 9 wherein the third material is a high durometer, dense or microdense material having a Shore hardness of about 55 A to about 45 D.

11. The weatherstrip assembly of claim 1 wherein the second material is a low durometer material having a Shore hardness of about 55 A to about 75 A.

12. The weatherstrip assembly of claim 11 wherein the third material is a high durometer, dense or microdense material having a Shore hardness of about 55 A to about 45 D.

13. The weatherstrip assembly of claim 1 wherein the third material is a high durometer, dense or microdense material having a Shore hardness of about 55 A to about 45 D.

14. The weatherstrip assembly of claim 1 wherein the weatherstrip assembly is a glass run assembly that receives an associated window edge therein, the body further having a generally U-shaped conformation that includes a base portion and first and second legs extending from the base portion to define a cavity, the glass run assembly further including a second seal lip wherein the first and second seal lips extend from the first and second legs, respectively, the glass run assembly further including a second hinge, and the first and second hinges are interposed between the first leg and the first seal lip, and the second leg and the second seal lip, respectively, and the second hinge is formed of the first material different than the second material of the seal lips.

15. The glass run assembly of claim 14 further comprising a third seal lip extending from one of the first and second legs and connected thereto by a third hinge formed of the first material.

16. A method of forming a weatherstrip assembly, the method comprising:
forming a body;
providing at least a first seal lip that extends from the body; and
incorporating a first hinge between the body and the first seal lip, where the hinge is formed of a first material different than a second material of the seal lip, and the first material has high elasticity, low compression set properties.

17. The method of claim 16 further comprising covering an interface of the first hinge with the first seal lip with a coating.

18. The method of claim 16 wherein the forming, providing, and incorporating steps include co-extruding the body, seal lip, and hinge.

19. The method of claim 16 further comprising using a high elasticity, low compression set durometer material for the first material.

20. The method of claim 16 further comprising using a low durometer dense or microdense material for the second material, and using a high durometer dense or microdense material for the third material.

21. The method of claim 16 wherein the weatherstrip assembly forming method includes forming a glass run assembly wherein the body forming step includes forming a base portion and first and second legs extending from the base portion to define a cavity, further providing a second seal lip wherein the first and second seal lips extend from the first and second legs, respectively, further incorporating a second hinge, and interposing the first and second hinges between the first leg and the first seal lip, and the second leg and the second seal lip, respectively, and the second hinge is formed of the first material different than the second material of the seal lips.
